(19) United States
(12) Patent Application Publication
(10) Pub. No.: US 2015/0006395 A1
(43) Pub. Date: Jan. 1, 2015

(54) Method for Wireless Charging Authentication and Related Wireless Charging System

(71) Applicant: HTC Corporation, Taoyuan County (TW)

(72) Inventor: Feng-Seng Chu, Taoyuan County (TW)

(21) Appl. No.: 14/320,672

(22) Filed: Jul. 1, 2014

Related U.S. Application Data
(60) Provisional application No. 61/841,431, filed on Jul. 1, 2013.
(60) Provisional application No. 61/897,833, filed on Oct. 31, 2013.
(60) Provisional application No. 61/925,665, filed on Jan. 10, 2014.
(60) Provisional application No. 61/979,010, filed on Apr. 14, 2014.

(51) Int. Cl. G06Q 20/40; G06Q 50/06

(52) U.S. Cl. CPC G06Q 20/40; G06Q 50/06
USPC 705/44

(57) ABSTRACT

A method of wireless charging authentication for a wireless charging device includes receiving an authentication information from an electronic device for authentication of charging; determining whether the authentication succeeds or not according to the authentication information; and supplying wireless power to the electronic device for charging if the authentication succeeds or stopping to supply wireless power to the electronic device if the authentication fails.

### CROSS REFERENCE TO RELATED APPLICATIONS

This application claims the benefit of U.S. Provisional Application No. 61/841,431, filed on Jul. 1, 2013 and entitled “Method and Apparatus to implement authentication in wireless charging systems”, U.S. Provisional Application No. 61/897,833, filed on Oct. 31, 2013 and entitled “Method and Apparatus to implement authentication in wireless power systems”, U.S. Provisional Application No. 61/925,665, filed on Jan. 10, 2014 and entitled “Method and Apparatus of authentication and payment for wireless charging”, and U.S. Provisional Application No. 61/979,010, filed on Apr. 14, 2014 and entitled “Method and Apparatus of authentication and payment for wireless charging”, the contents of which are incorporated herein in their entirety.

### BACKGROUND OF THE INVENTION

1. Field of the Invention

The present invention relates to a method used in a wireless charging system and related wireless charging device, and more particularly, to a method of wireless charging authentication in a wireless charging system and related wireless charging device.

2. Description of the Prior Art

With the proliferation of portable electronic devices such as mobile device (MD), smart phone and tablet PC, the demand for charging devices, especially for those provided in public areas, is increasing. In addition, people would like to get rid of annoying wires if possible. One technology which realizes this desire is wireless charging, in which portable electronic device(s) comprising a power receiver is placed on and charged through a wireless charging device (e.g. a power base station comprising a power transmitter). Therefore, the current trend aims at providing wireless charging in public areas such as coffee shops, stores, train stations, airports, and restaurants, so that people can easily find a wireless power supply to charge their portable electronic devices.

Wireless Power Consortium (WPC) is a leading organization in the world to define wireless charging specifications. The document “Wireless Power Transfer—Volume I, part I” and the document “Wireless Power Transfer—Volume 2, part I” define the interaction between a power base station (or a power transmitter) and a mobile device (or a power receiver).

However, all the existing protocol states are used for power charging and there is no consideration for other applications. The place which provides wireless charging cannot bill their customer for power charging, since there is no authentication in the protocol.

Therefore, there is a need to implement authentication mechanism for wireless charging in order to meet the business requirement of deploying wireless charging services in public areas.

### SUMMARY OF THE INVENTION

An objective of the present invention is to provide a method and related wireless charging device and wireless charging system for wireless charging authentication.

The present invention discloses a method of wireless charging authentication for a wireless charging device. The method includes receiving an authentication information from an electronic device for authentication of charging; determining whether the authentication succeeds or not according to the authentication information; and supplying wireless power to the electronic device for charging if the authentication succeeds or stopping to supply wireless power to the electronic device if the authentication fails.

The present invention further discloses a wireless charging system. The wireless charging system includes an electronic device; and a wireless charging device, for providing wireless power to charge at least one electronic device including said electronic device. The wireless charging device is configured to receive an authentication information from the electronic device for authentication of charging, determine whether the authentication succeeds or not according to the authentication information, and supply wireless power to the electronic device for charging if the authentication succeeds or stop supplying wireless power to the electronic device if the authentication fails.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless charging system according to an example of the present invention.

FIG. 2 is a functional block diagram of a wireless charging system according to an example of the present invention.

FIG. 3 illustrates a schematic diagram of a wireless charging system in accordance with an example of the present invention.

FIG. 4 is a flowchart of a process according to an example of the present invention.

FIG. 5 shows a signal diagram of a wireless charging authentication procedure where there is a communication channel from the power base station to the mobile device according to an example of the present invention.

FIG. 6 shows a signal diagram of a wireless charging authentication procedure where there is no communication channel from the power base station to the mobile device according to an example of the present invention.

FIG. 7 shows a signal diagram of a wireless charging authentication procedure where there is no communication channel from the power base station to the mobile device according to another example of the present invention.

FIG. 8 shows a signal diagram of a wireless charging authentication procedure according to an example of the present invention.

FIG. 9 shows a signal diagram for the steps executed when the power base station determines that the authentication is failed according to an example of the present invention.

FIG. 10 shows a signal diagram for the steps executed when the power base station determines that the authentication is failed according to an example of the present invention.

FIG. 11 shows a signal diagram for the steps executed when the power base station determines that the authentication is failed according to an example of the present invention.

FIG. 12 shows a signal diagram for the steps executed when the power base station determines that the authentication is failed according to an example of the present invention.

FIG. 13 shows a signal diagram of a wireless charging authentication procedure according an example of the present invention.

### DETAILED DESCRIPTION

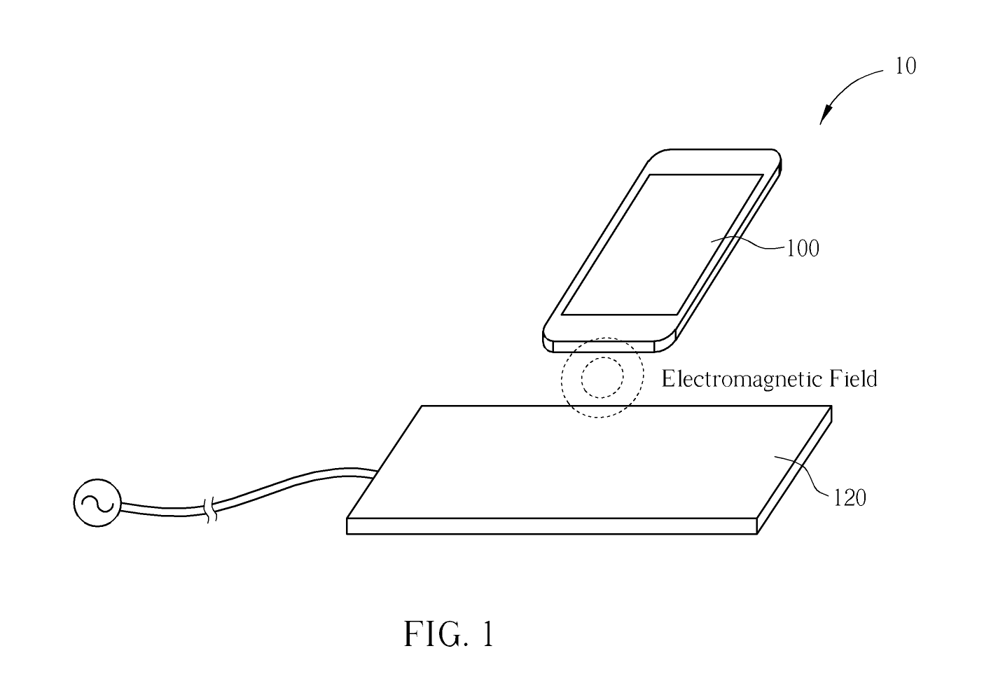

Please refer to FIG. 1, which illustrates a schematic diagram of a wireless charging system 10 according to an example of the present disclosure. A wireless charging system may include at least one wireless charging device and at least one electronic device that can be charged by the wireless charging device. For simplicity, in FIG. 1, the wireless charging system 10 is briefly composed of an electronic device 100 and a wireless charging device 120. The wireless charging device 120 may represent a power base station (PBS), including a power transmitter or a power transmitting module with digital/analog chip(s), to supply wireless power to the electronic device 100. The electronic device 100 may be any portable electronic device such as a mobile device (MD), a mobile phone, a laptop, a tablet computer, an electronic book, a portable computer system, or at least a power receiver or a power receiving module. Alternatively, the electronic device 100 may be any electronic device using battery as its power supply, such as a wearable computing device, a wearable medical device, a portable MP3 player, etc. The electronic device 100 may directly attach to the wireless charging device 120 or keep within a distance from the wireless charging device 120 for wireless charging. As shown in FIG. 1, the electronic device 100 receives wireless power from the wireless charging device 120 by electromagnetic induction so that the battery of the electronic device 100 is charged without using any wire connection.

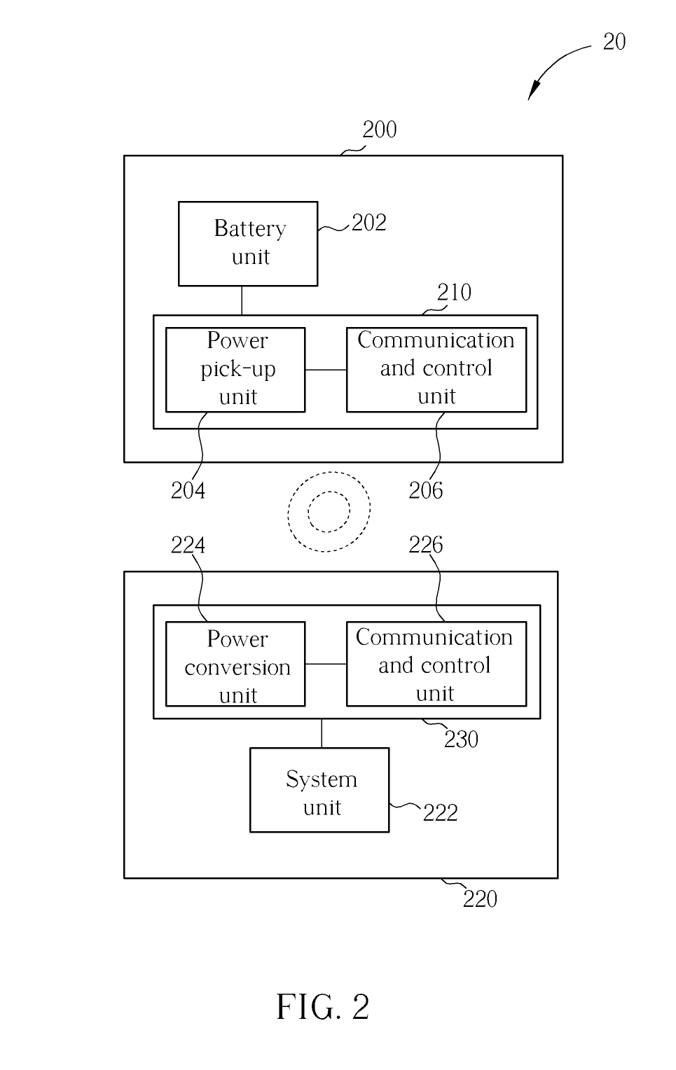

Please refer to FIG. 2, which is a functional block diagram of a wireless charging system 20 according to an example of the present invention. The wireless charging system 20 includes an electronic device 200 and a wireless charging device 220. The electronic device 200 may be the electronic device 100 shown in FIG. 1, and the wireless charging device 220 may be the wireless charging device 120 shown in FIG. 1. The electronic device 200 includes a battery unit 202 and a power receiver 210. The power receiver 210 may include a power pick-up unit 204 used for receiving wireless power to charge the battery unit 202 and a communication and control unit 206 used for communicating, i.e., sending/receiving signals or packets, with the wireless charging device 220 via power signals and controlling the operation of the power pick-up unit 204.

The wireless charging device 220 includes a power transmitter 230 and a system unit 222. The power transmitter 230 may include a power conversion unit 224 used for supplying wireless power and a communication and control unit 226 used for communicating, i.e., sending/receiving signals or packets, with the electronic device 200 and controlling the operation of the power conversion unit 224. The system unit 222 may include a processing means such as a microcontroller, microprocessor or an Application Specific Integrated Circuit (ASIC), for handling wireless charging authentication function activated by a processing result of the power transmitter 230. In the example of FIG. 2, the wireless charging device 220 contains one power transmitter 230. In other examples, the wireless charging device may contain multiple power transmitters for supplying wireless power to multiple portable electronic devices.

The communication and control units 206 and 226 preferably utilize an in-band communication channel for communication, in which communication channels are attached on wireless power signal. In an example, communication from wireless charging device 220 to electronic device 200 may be carried out by using frequency-shift keying (FSK) modulation on the wireless power for transmission. In another example, communication from electronic device 200 to wireless charging device 220 may rely on load modulation (LM). Alternatively, the communication and control units 206 and 226 may be implemented by radio transceivers that transmit and receive radio signals (e.g., messages, emails, or packets) in an out-of-band communication channel (e.g. a short-range communication protocol such as Bluetooth, Bluetooth LE, Wi-Fi).

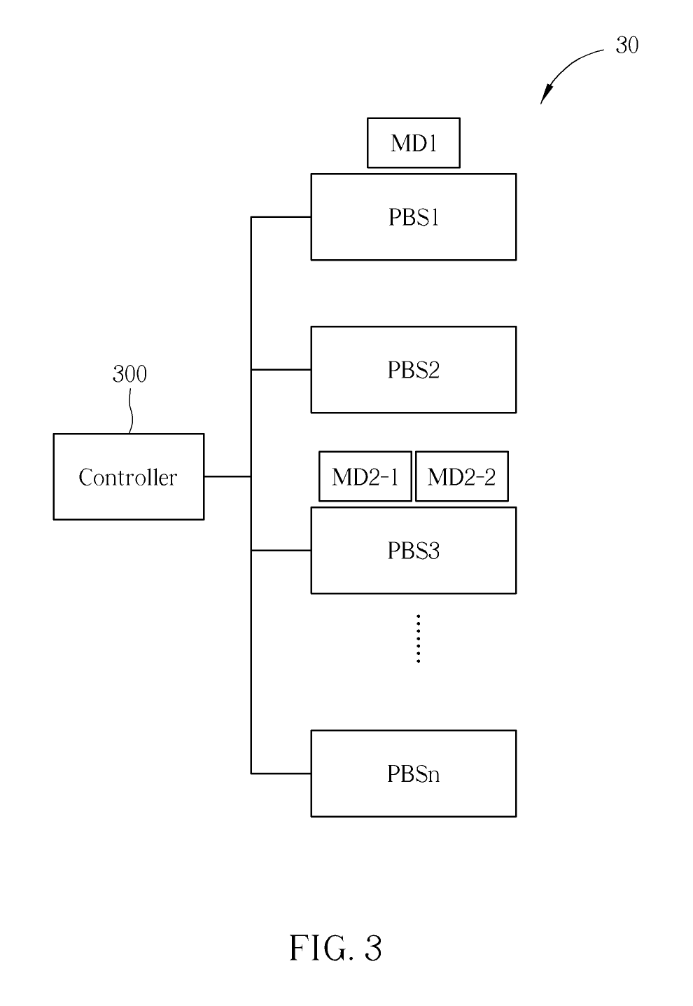

FIG. 3 illustrates a schematic diagram of a wireless charging system 30 in accordance with an example of the present invention. The wireless system 30 include mobile devices MD1, MD2-1, MD2-2, power base stations PBS1-PBSn, and a controller 300 connected to each of the power base stations. The power base stations PBS1-PBSn may be deployed in areas such as coffee shops, stores, train stations, airports, and restaurants for public use. The controller 300 may be a computer or a server at a control center or a front desk of the public area that monitors the usage or performs necessary computation for the power base stations PBS1-PBSn. In addition, if the user of a certain power base station encounters any problem, signals or messages relating to the power base station may be sent to the controller 300 so that people in the control center or the front desk can provide timely assistance. Note that a wireless charging device may be able to charge more than one electronic devices at the same time, as the example of the power base station PBS3 charging the mobile devices MD2-1 and MD2-2 shown in FIG. 3. Therefore, signals or the messages sent to the controller 300 may include necessary information (e.g. an identity of the mobile device) to distinguish the mobile devices MD2-1 and MD2-2 if only one of them encounters problem during wireless charging.

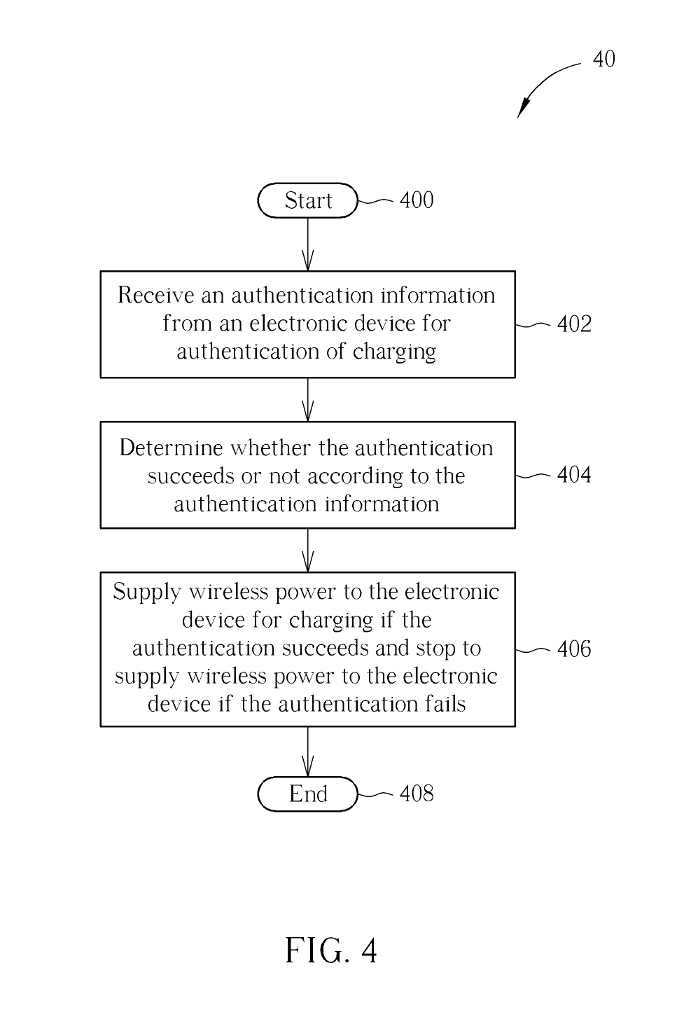

Please refer to FIG. 4, which is a flowchart of a process 40 according to an example of the present invention. The process 40 may be utilized for a wireless charging device, such as the wireless charging device 120 shown in FIG. 1, to realize wireless charging authentication in a wireless charging system. The wireless charging device is able to detect its proximity and know whether an electronic device with a power receiver comes close to the wireless charging device. After the wireless charging device detects the electronic device, it starts the process 40, which includes the following steps:

Step 400: Start.

Step 402: Receive an authentication information from an electronic device for authentication of charging.

Step 404: Determine whether the authentication succeeds or not according to the authentication information.

Step 406: Supply wireless power to the electronic device for charging if the authentication succeeds or stop to supply wireless power to the electronic device if the authentication fails.

Step 408: End.

According to the process 40, the wireless charging device is configured to receive the authentication information from the electronic device, and determine whether the electronic device is authorized for receiving wireless power according to the received authentication information. The authentication information may be included in a message sent by the electronic device via an in-band communication channel or an out-of-band communication channel. In the case of using out-of-band communication channel, the wireless charging device may start supplying wireless power if the authentication succeeds. If the authentication fails, the wireless charging device may avoid supplying wireless power or release a warning signal. In the case of using in-band communication channel, the wireless charging device has already supplied wireless power before receiving the authentication information. In such a condition, the wireless charging device keeps on supplying wireless power if the authentication succeeds. If the authentication fails, the wireless charging device may stop supplying wireless power or release a warning signal. In this manner, the service of wireless charging is under control.

Note that the process 40 is an example of the present invention. Those skilled in the art should readily make combinations, modifications and/or alterations on the abovementioned description and examples. For example, the wireless charging device may have a configuration for enabling or disabling the wireless charging authentication function. Thus, the owner of the wireless charging device can configure whether to execute the process 40 or not.

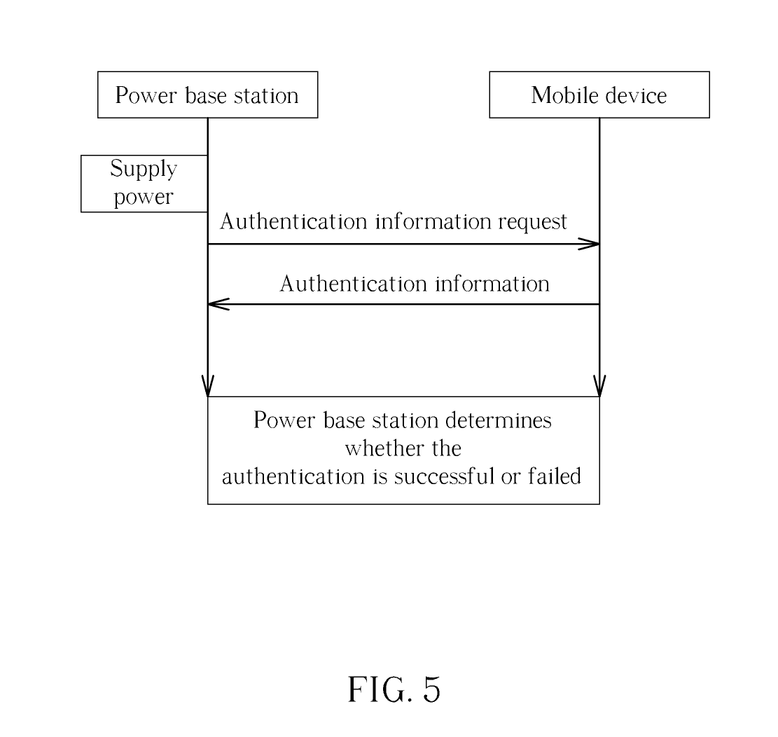

In an example, the wireless charging device may send an authentication information request to the electronic device, and receive the authentication information from the electronic device. The authentication information request may be included in a message sent from the wireless charging device to the electronic device. When the electronic device receives the authentication information request, it may send the authentication information to the wireless charging device in response or send a notice (may be included in a message) to inform that the electronic device does not intend to receive wireless power from the wireless charging device. This example is applicable to a wireless charging system where there is a communication channel from the wireless charging device to the electronic device. The signal diagram of this example is shown in FIG. 5.

The above describes the example where the wireless charging authentication procedure is initiated by the wireless charging device. In some cases, the wireless charging authentication procedure (or the communication) may be initiated by the electronic device. The electronic device may send a query message to the wireless charging device to explicitly ask whether the authentication is needed. In response, the wireless charging device may send a first response to the electronic device to indicate whether the authentication is needed or not. If the electronic device receives the first response indicating that the authentication is needed, the electronic device sends the authentication information to the wireless charging device in a message, and the system proceeds to the Step 402.

Alternatively, the electronic device may send a default authentication information to the wireless charging device to initiate the wireless charging authentication procedure. This example is regarded as an implicit query about whether the authentication is needed. The default authentication information may be any code such as a series of zero bits, numbers (e.g. 1234), or any identity (ID) of the electronic device. If the electronic device receives a negative-acknowledgement (NACK) from the wireless charging device, it understands that the authentication is needed, and then the system proceeds to the wireless charging authentication procedure.

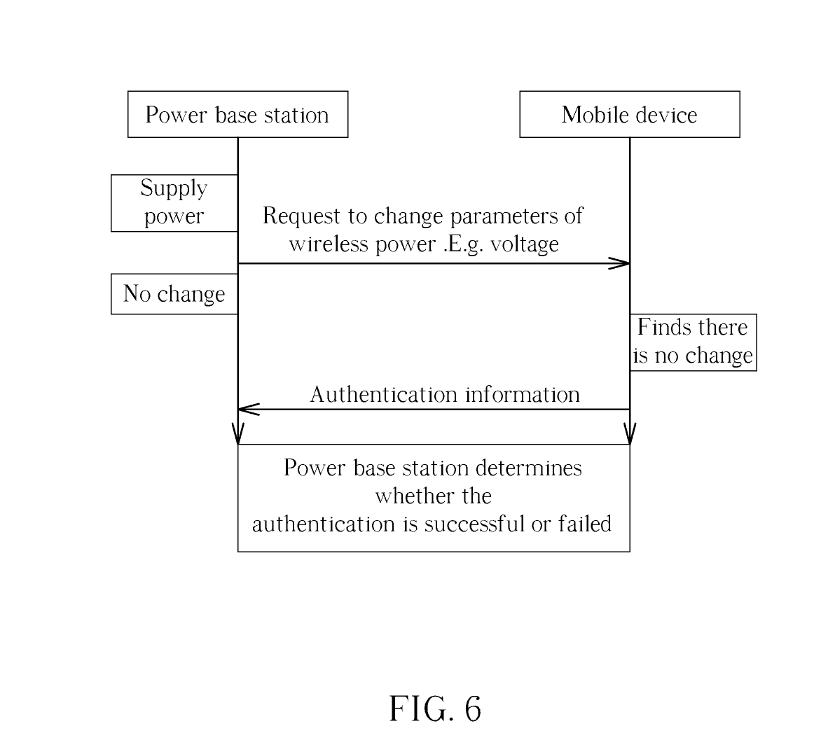

In some examples, the wireless charging system does not support a communication channel from the wireless charging device to electronic device. In order to know whether the wireless charging authentication is required, the electronic device may send a message or a packet (e.g. a control error packet or reconfiguration packet) to request the wireless charging device to adjust/increase/decrease/reconfigure a parameter (e.g. voltage, current, amplitude, duty cycle, frequency, or power in watt) of the wireless power and then detect if there is any change in the wireless power. If the electronic device does not detect that the parameter changes over a threshold, the electronic device determines that wireless charging authentication is needed and sends the authentication information to the wireless charging device. The signal diagram of this example is shown in FIG. 6.

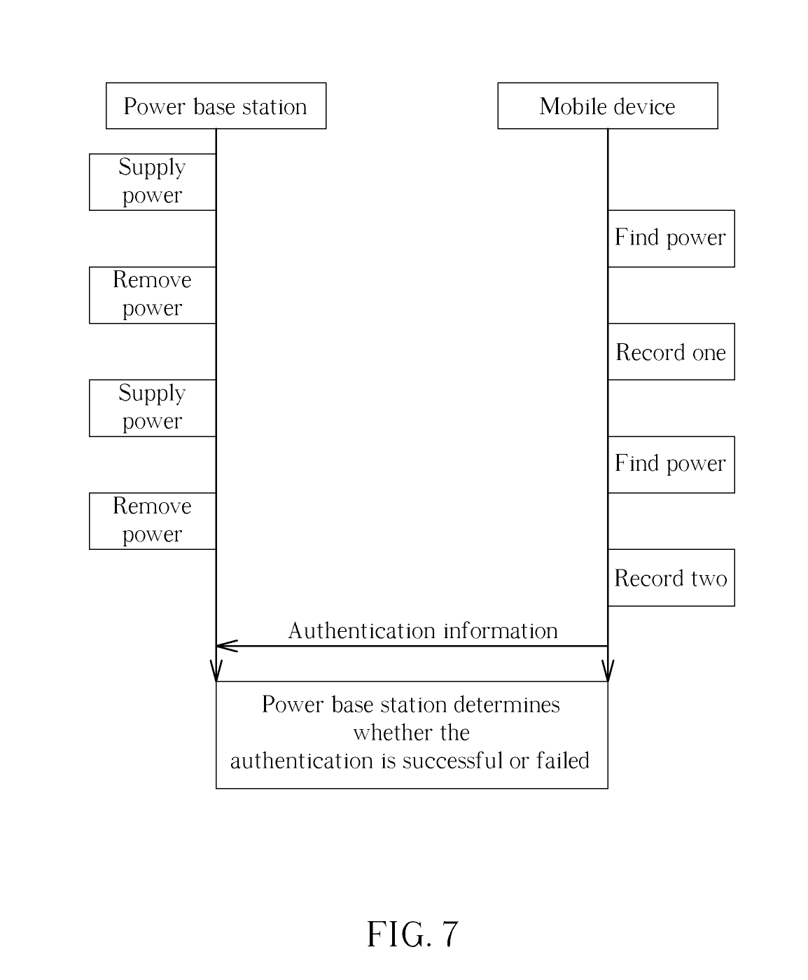

Alternatively, the electronic device may record the number of times that the wireless charging device removes or restarts wireless power within certain duration. If the electronic device detects that the wireless power is on and off for more than a predefined number of times within a certain duration, the electronic device knows that the authentication is required and may send the authentication information to the wireless charging device, or send a notice (may be included in a message) to inform that the electronic device does not intend to receive wireless power from the wireless charging device. This example is also applicable for the case when the wireless charging system does not support a communication channel from the wireless charging device to electronic device. The signal diagram of this example is shown in FIG. 7. The examples regarding FIG. 6 and FIG. 7 may be combined together for indicating to the electronic device that the authentication is needed.

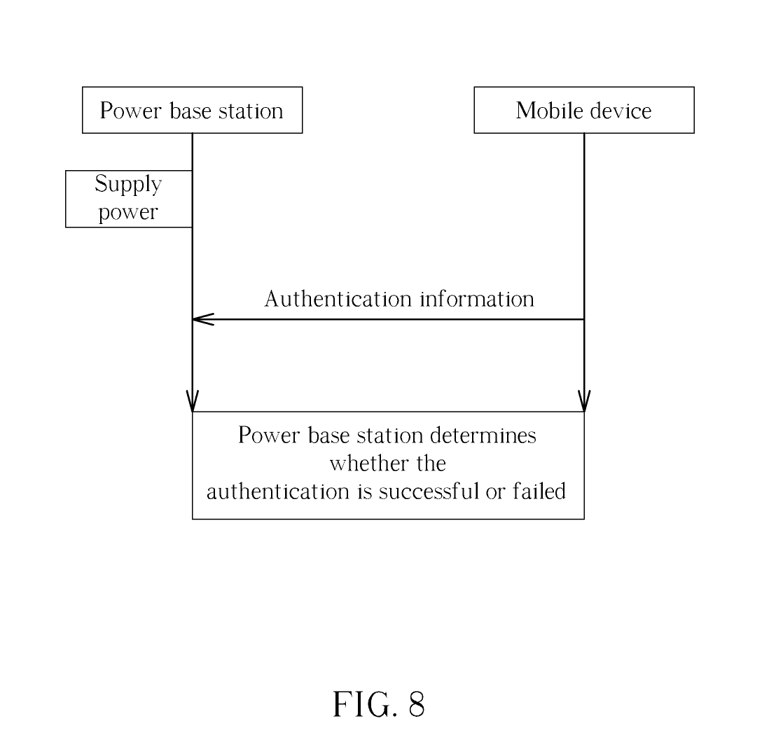

In an example, the electronic device may send the authentication information upon starting to receive wireless power or send the notice to inform that it does not intend to receive wireless power from the wireless charging device, regardless of whether the communication channel from the wireless charging device to electronic device is supported or not. So this example is applicable for both cases when the wireless charging system supports a communication channel from the wireless charging device to electronic device (i.e. the system supports bidirectional communication between the wireless charging device and the electronic device) and when the wireless charging system does not support a communication channel from the wireless charging device to the electronic device. The signal diagram of this example is shown in FIG. 8.

The authentication information may comprise a security code, a password, full or partial of an identity of the electronic device, an input to the electronic device, and information indicating that a user of the electronic device has completed a certain operation on the electronic device (e.g. the user had clicked an advertisement link). The security code and the password may be represented by a series of bits, any possible input to the electronic such as a plot and a series of numbers, or an image (e.g. user's face or fingerprint) recognized by the electronic device. The identity of the electronic device may be a unique ID of the power receiver (e.g., the power receiver 210) equipped in the electronic device. This identity may be determined by the manufacturer of the power receiver, such as the device ID which includes Manufacture Code and (Basic/Extended) Device Identifier. Alternatively, the identity of the electronic device may be represented by other modules in the electronic device. In an example, it may be the International Mobile Subscriber Identity (IMSI) or the Radio Network Temporary Identifier (RNTI) from cellular modules in the electronic device. In another example, it may be the Near Field Communication (NFC) or Bluetooth low energy (BLE) ID from NFC or Bluetooth modules in the electronic device. The identity of the electronic device which is represented by the identity of modules other than the receiver module may be encoded (e.g. scrambled, truncated) before sending to the wireless charging device as the authentication information.

A timer may be set in the wireless charging device at the beginning of the wireless charging procedure for waiting the authentication information. If the wireless charging device receives the authentication information within a predefined duration, it checks whether the authentication succeeds or fails. On the other hand, if the wireless charging device does not receive the authentication information for the predefined duration, the wireless charging device may determine that the authentication is failed.

The wireless charging device may determine whether the authentication succeeds or not by comparing the received authentication information with data stored in a memory of the wireless charging device. In other words, the wireless charging device compares the received authentication information (e.g. a password) with the authentication information data (e.g. a referenced password) stored in its memory. If it matches, the authentication is successful. If it does not match, the authentication is failed.

In another aspect, the wireless charging device may determine whether the authentication succeeds or not by manipulating the received authentication information and checking if a value derived from manipulation of the received authentication information equals a predefined value. In a case when the authentication information is a number, for example, the wireless charging device may take modulo operation on the number by a predetermined number. If the remainder matches a specific number, the authentication is successful; otherwise, the authentication is failed.

The above descriptions illustrate examples where the wireless charging device verifies the authentication information locally. In some cases, the wireless charging device may be managed by a remote device so that the authentication information may be processed in the remote device instead. In such a situation, the wireless charging device may send the received authentication information to a controller (e.g., the controller 300 as shown in FIG. 3) of the wireless charging system for determining the authentication succeeds or not by the controller. The controller may perform manipulation on the authentication information and compare to check if the derived value equals the predefined value. Then, the controller sends the comparison result back to the wireless charging device.

If the authentication succeeds, the wireless charging device may send an authentication success message to the controller to inform that the authentication of the electronic device succeeds. The authentication success message may comprise at least one of the following: an identity of the electronic device, an identity of the wireless charging device, and a location of the wireless charging device or the electronic device.

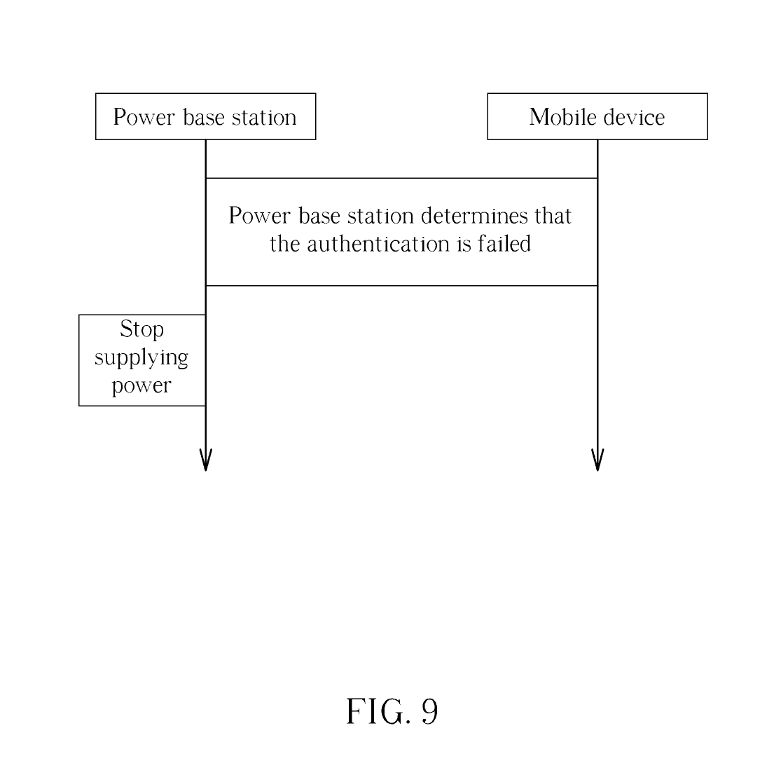

If the authentication fails, the wireless charging device may stop supplying power, as shown in the signal diagram of FIG. 9. In an example, the wireless charging device may request the authentication information from the electronic device again after it determines the authentication fails.

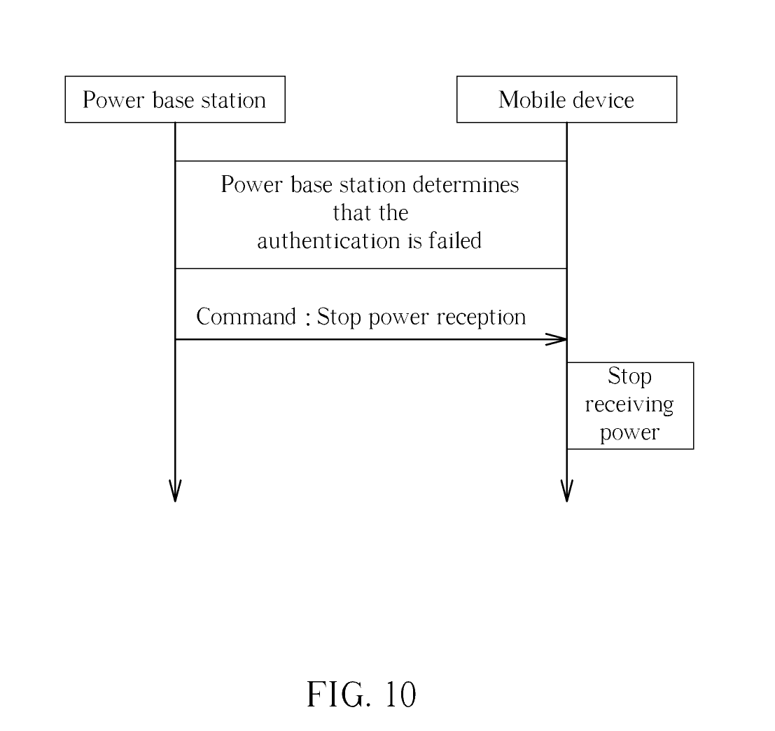

Referring to the example shown in FIG. 10, if the authentication fails, the wireless charging device may send a first command (e.g. a stop power reception command) to the electronic device which requests the electronic device to stop receiving wireless power from the wireless charging device. When the electronic device receives the first command, it should stop receiving wireless power. If the electronic device does not need charging (e.g. the battery is full), it may send a notice (which may be included in a message) to inform that the electronic device does not intend to receive wireless power from the wireless charging device.

Moreover, the wireless charging device may send a second command to the electronic device which requests the electronic device to resend the authentication information when the authentication fails or when the wireless charging device is supplying wireless power. When the electronic device receives the second command, it may resend the authentication information to the wireless charging device or send a notice (which may be included in a message) to inform that the electronic device does not intend to receive wireless power from the wireless charging device.

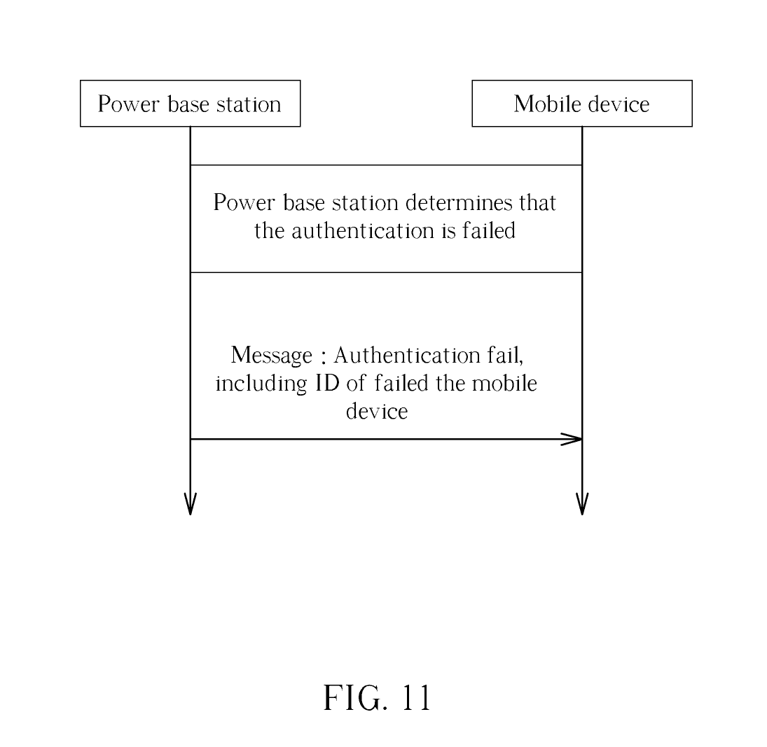

Referring to the example shown in FIG. 11, the wireless charging device may send an authentication failure message to a controller (e.g. controller 300) if the authentication fails. The authentication failure message informs the controller that the authentication for the electronic device fails. The authentication failure message may comprise at least one of the following: an identity of the electronic device, an identity of the wireless charging device, a location of the wireless charging device or the electronic device, and the reason of authentication failure. Thus, people who monitor the controller can diagnose the failure issue based on the authentication failure message and provide assistance if needed.

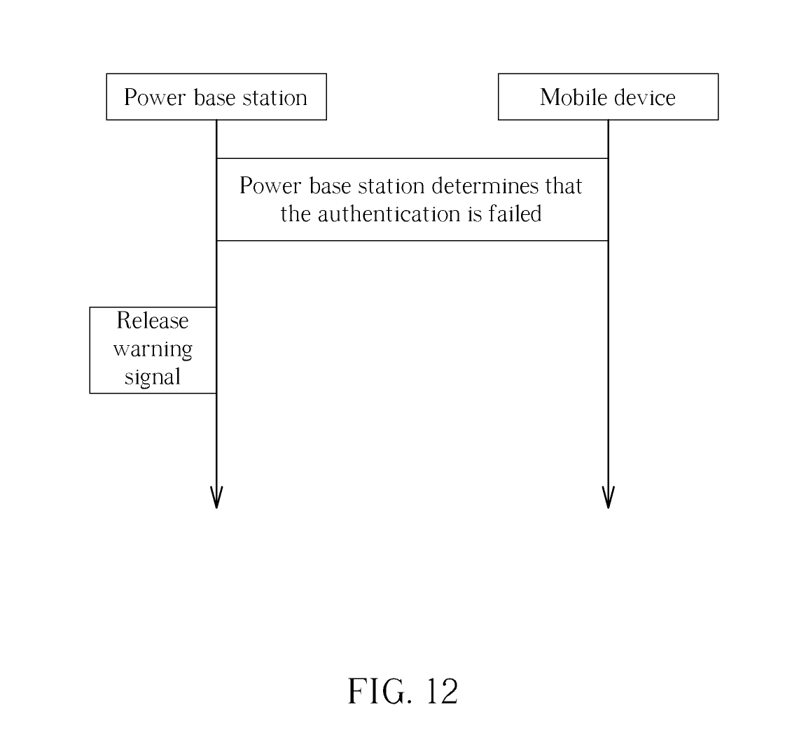

Referring to the example shown in FIG. 12, when the authentication fails, the wireless charging device may release a warning signal, which can bring immediate attentions of the surrounding people. The warning signal may be in any forms such as voice, speech, audio, image, and/or video.

To make sure that the electronic device is not replaced by other device during wireless charging, the wireless charging device may send a third command to the electronic device to request authentication information again. When the electronic device receives the third command, it sends authentication information to the wireless charging device. Alternatively, the electronic device may spontaneously send the authentication information to the wireless charging device from time to time during wireless charging so that the wireless charging device may receive the authentication information from the electronic device periodically.

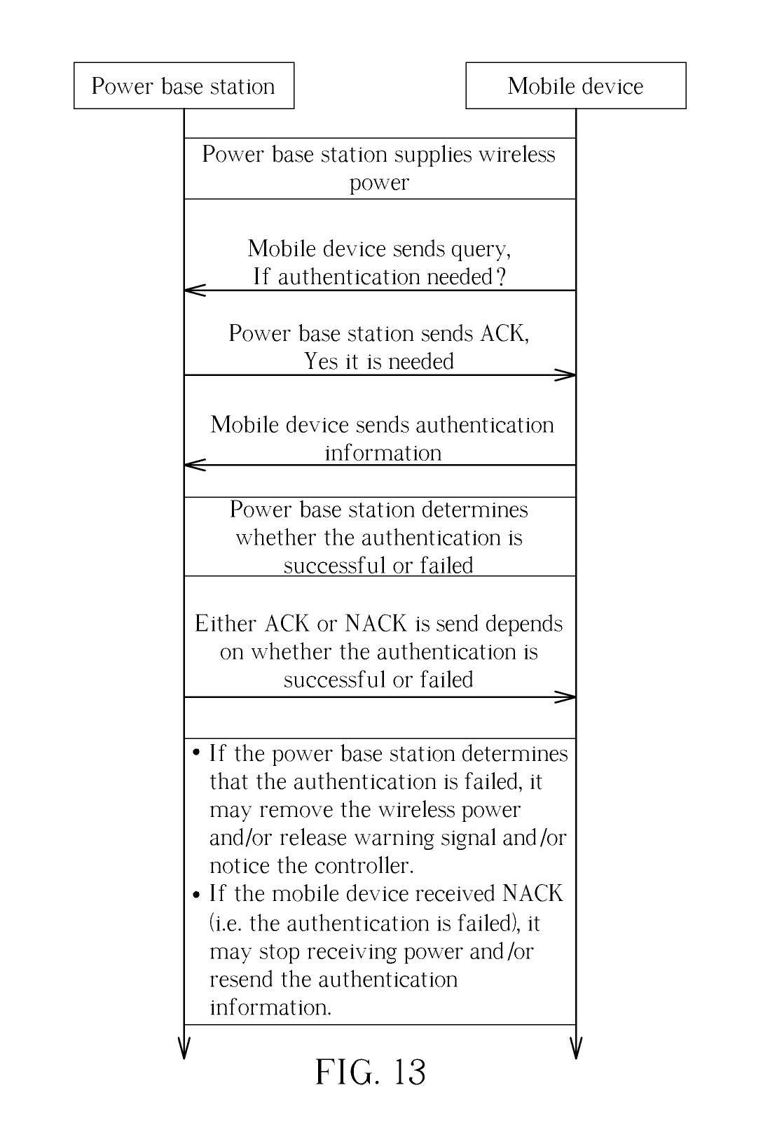

Referring to the example shown in FIG. 13, the wireless charging device may send a second response to the electronic device to indicate whether the authentication succeeds or fails after determining the authentication result. The second response may be in a form of acknowledgement (ACK)/negative-acknowledgement (NACK). If the electronic device receives a NACK, it may display an error message on the screen of the electronic device so that the user can know what happened.

If the wireless charging authentication procedure completes and the authentication fails, the wireless charging system may restart the protocol cycle from the beginning. For example, in a wireless charging system conforming to the WPC specification, the wireless charging system may rewind to the selection phase to start over the protocol cycle. Alternatively, the wireless charging system may go back to one of the previous protocol phases (e.g. ping phase, identification and configuration phase, or negotiation phase).

The abovementioned steps of the process 40 including suggested steps may be realized by means of hardware, software, firmware, or an electronic system. Examples of hardware may include analog, digital and mixed circuits known as microcircuit, microchip, or silicon chip. Examples of the electronic system may include a system on chip (SOC), system in package (SiP), and a computer on module (COM).

To sum up, the present invention provides a method and related wireless charging device and wireless charging system for wireless charging authentication. The present invention may be applied to wireless power systems which requires payment for wireless charging, or wireless power systems which provides free charging service. In some situations, the wireless charging authentication may be enabled in order to block unauthorized charging. The type of service (e.g., free or not free) which the wireless charging system provides may depend on the configurations of the wireless charging systems. Since the present invention can be applied to wireless power systems which provides free charging services, the wireless charging device is backward compatible, and is also suitable for private use.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of wireless charging authentication for a wireless charging device, comprising:
receiving an authentication information from an electronic device for authentication of charging;
determining whether the authentication succeeds or not according to the authentication information; and
supplying wireless power to the electronic device for charging if the authentication succeeds or stopping to supply wireless power to the electronic device if the authentication fails.

2. The method of claim 1, further comprising:
sending a first response to the electronic device to indicate whether the authentication is needed in response to a query received from the electronic device.

3. The method of claim 1, wherein the step of determining whether the authentication succeeds or not according to the authentication information comprises:
determining that the authentication fails if the wireless charging device does not receive the authentication information for a predefined duration.

4. The method of claim 1, further comprising:
sending a second response to the electronic device to indicate whether the authentication succeeds or fails.

5. The method of claim 1, wherein the wireless charging device starts supplying wireless power or keeps on supplying wireless power if the authentication succeeds.

6. The method of claim 1, wherein the wireless charging device stops supplying wireless power or releases a warning signal if the authentication fails.

7. The method of claim 1, wherein the wireless charging device receives the authentication information from the electronic device periodically.

8. The method of claim 1, wherein the authentication information comprises at least one of a security code, a password, full or partial of an identity of the electronic device, an input to the electronic device, and information indicating that a user of the electronic device has completed a certain operation on the electronic device.

9. The method of claim 1, wherein the wireless charging device determines whether the authentication succeeds or not by comparing the received authentication information with data stored in a memory of the wireless charging device.

10. The method of claim 1, wherein the wireless charging device determines whether the authentication succeeds or not by manipulating the received authentication information and checking if a value derived from manipulation of the received authentication information equals a predefined value.

11. The method of claim 1, wherein the step of determining whether the authentication succeeds or not according to the authentication information comprises:
sending the received authentication information to a controller for determining the authentication succeeds or not by the controller.

12. The method of claim 1, further comprising:
sending an authentication success message to a controller to inform that the authentication for the electronic device succeeds;
wherein the authentication success message comprises at least one of an identity of the electronic device, an identity of the wireless charging device, and a location of the wireless charging device or the electronic device.

13. The method of claim 1, further comprising:
sending an authentication failure message to a controller to inform that the authentication for the electronic device fails;
wherein the authentication failure message comprises at least one of an identity of the electronic device, an identity of the wireless charging device, a location of the wireless charging device or the electronic device, and the reason of authentication failure.

14. The method of claim 1, further comprising:
sending a request to the electronic device for receiving the authentication information from the electronic device.

15. A wireless charging system, comprising:
an electronic device; and
a wireless charging device, for providing wireless power to charge at least one electronic device comprising the electronic device;
wherein the wireless charging device is configured to receive an authentication information from the electronic device for authentication of charging, determine whether the authentication succeeds or not according to the authentication information, and supply wireless power to the electronic device for charging if the authentication succeeds or stop supplying wireless power to the electronic device if the authentication fails.

16. The wireless charging system of claim 15, wherein the wireless charging device is further configured to send a first response to the electronic device to indicate whether the authentication is needed in response to a query received from the electronic device.

17. The wireless charging system of claim 15, wherein the wireless charging device determines that the authentication fails if the wireless charging device does not receive the authentication information for a predefined duration.

18. The wireless charging system of claim 15, wherein the wireless charging device is further configured to send a second response to the electronic device to indicate whether the authentication succeeds or fails.

19. The wireless charging system of claim 15, wherein the wireless charging device starts supplying wireless power or keeps on supplying wireless power if the authentication succeeds.

20. The wireless charging system of claim 15, wherein the wireless charging device stops supplying wireless power or releases a warning signal if the authentication fails.

21. The wireless charging system of claim 15, wherein the wireless charging device receives the authentication information from the electronic device periodically.

22. The wireless charging system of claim 15, wherein the authentication information comprises at least one of a security code, a password, an identity of the electronic device, an input to the electronic device, and information indicating that a user of the electronic device has completed a certain operation on the electronic device.

23. The wireless charging system of claim 15, wherein the wireless charging device determines whether the authentication succeeds or not by comparing the received authentication information with data stored in a memory of the wireless charging device.

24. The wireless charging system of claim 15, wherein the wireless charging device determines whether the authentication succeeds or not by manipulating the received authentication information and checking if a value derived from manipulation of the received authentication information equals a predefined value.

25. The wireless charging system of claim 15, wherein the wireless charging device sends the received authentication information to a controller of the wireless charging system for determining the authentication succeeds or not by the controller.

26. The wireless charging system of claim 15, wherein the wireless charging device is further configured to send an authentication success message to a controller of the wireless charging system to inform that the authentication for the electronic device succeeds, wherein the authentication success message comprises at least one of an identity of the electronic device, an identity of the wireless charging device, and a location of the wireless charging device or the electronic device.

27. The wireless charging system of claim 15, wherein the wireless charging device is further configured to send an authentication failure message to a controller of the wireless charging system to inform that the authentication for the electronic device fails, wherein the authentication failure message comprises at least one of an identity of the electronic device, an identity of the wireless charging device, a location of the wireless charging device or the electronic device, and the reason of authentication failure.

28. The wireless charging system of claim 15, wherein the wireless charging device is further configured to send a request to the electronic device for receiving the authentication information from the electronic device.

29. The wireless charging system of claim 15, wherein the electronic device sends a default authentication information to the wireless charging device and understands that the authentication is needed if the electronic device receives a negative-acknowledgement (NACK) from the wireless charging device.

30. The wireless charging system of claim 15, wherein the electronic device is configured to send a notice to inform that the electronic device does not intend to receive wireless power from the wireless charging device.

31. The wireless charging system of claim 15, wherein the electronic device requests the wireless charging device to adjust a parameter of the wireless power, and sends the authentication information to the wireless charging device if the electronic device does not detect that the parameter changes over a first threshold.

32. The wireless charging system of claim 15, wherein the electronic device sends the authentication information to the wireless charging device or sends a notice to inform that the electronic device does not intent to receive wireless power from the wireless charging device if the electronic device detects that the wireless power is on and off for more than a predefined number of times.

33. The wireless charging system of claim 15, wherein the wireless charging device is further configured to send a first command to the electronic device which requests the electronic device to stop receiving wireless power from the wireless charging device.

34. The wireless charging system of claim 15, wherein the wireless charging device is further configured to send a second command to the electronic device which requests the electronic device to resend the authentication information when the authentication fails or when the wireless charging device is supplying wireless power.
